(19) United States
(12) Patent Application Publication
(10) Pub. No.: US 2020/0263850 A1
(43) Pub. Date: Aug. 20, 2020

(54) ILLUMINATION DEVICE AND VEHICULAR HEADLIGHT

(71) Applicant: SHARP KABUSHIKI KAISHA

(72) Inventors: YOSHINOBU KAWAGUCHI, Sakai City (JP); KOJI TAKAHASHI, Sakai City (JP); YOSHIYUKI TAKAHIRA, Kizugawa City, Kyoto (JP)

(73) Assignees: SHARP KABUSHIKI KAISHA, Sakai City, Osaka (JP); SHARP KABUSHIKI KAISHA, Sakai City, Osaka (JP)

(21) Appl. No.: 16/061,645

(22) PCT Filed: Aug. 5, 2016
(86) PCT No.: PCT/JP2016/073092

§ 371 Date: Jun. 12, 2018

(30) Foreign Application Priority Data
Dec. 17, 2015 (JP) 2015-246754

(51) Int. Cl. F21S 41/675; G02B 26/10; F21S 41/16; F21S 41/176; F21S 41/33; B60Q 1/08

(52) U.S. Cl. CPC F21S 41/675; G02B 26/101; F21S 41/16; F21S 45/47; F21S 41/337; B60Q 1/08; F21S 41/176

(57) ABSTRACT

Provided are an illumination device that is capable of making linearly clear a bright-dark contrast of a boundary between an illumination region and a dark portion in at least one of a horizontal direction and a vertical direction, and a vehicular headlight. The illumination device (1A) includes an emitting section (15) having a phosphor that receives excitation light emitted from a laser element (2c) and emits light; and a movable mirror (20A) that continuously changes a position of a spot (15a) of the excitation light on the emitting section (15) in accordance with a predetermined rule. The spot (15a) has an edge portion in which at least a pair of two opposing sides are linear.

### TECHNICAL FIELD

The present invention relates to an illumination device Including an emitting section having a phosphor that receives excitation light emitted from an excitation light source and that emits light, and to a vehicular headlight.

### BACKGROUND ART

Hitherto, a technology of acquiring a white light source by irradiating an emitting section containing a phosphor with laser light and by exciting the phosphor is known.

As an application example of this type of technology, for example, at a headlight for an automobile, external states involving, for example, oncoming vehicles, pedestrians, traffic sighs, and road surfaces are monitored by a camera, and in order to acquire a suitable projection pattern in accordance with the external states, the white light source is caused to emit light having a shape corresponding to a projection pattern to be projected. Such a mechanism is called, for example, Adaptive Driving Beam.

For example, as shown in FIG. 19, a vehicular lighting fixture 100 disclosed in Patent Literature 1 includes individual phosphors 101a, formed by dividing a rectangular phosphor 101 into a plurality of portions. By individually performing on/off illumination on the individual phosphors 101a with lights from different light sources, it is possible to form a predetermined projection pattern.

On the other hand, a technology of arbitrarily changing the shape of light emitted from the white light source by scanning a phosphor with laser light that excites the phosphor is known.

For example, as shown in FIG. 20, a vehicular lighting fixture 200 disclosed in Patent Literature 2 includes an excitation light source 201, a mirror section. 202 that allows two-dimensional scanning in a horizontal direction and a vertical direction by using incident excitation light, an emitting section 203 that contains a phosphor which is irradiated with the light from the mirror section 202, and a projecting lens 204.

In this way, in the vehicular lighting fixture 200, in particular, it is possible to acquire various light distribution patterns due to a residual image effect scanning the phosphor with laser light that excites the phosphor. As a result, it is possible to arbitrarily change projection patterns of light emitted from the vehicular lighting fixture 200.

As a result, it is possible to arbitrarily change projection patterns without increasing the number of components.

### CITATION LIST

### Patent Literature

PTL 1: Japanese Unexamined Patent Application Publication No. 2015-005439 (laid open on. Jan. 8, 2015)
PTL 2: Japanese Unexamined Patent Application Publication No. 2015-138735 (laid open on Jul. 30, 2015)
PTL 3: Japanese Unexamined Patent Application Publication No. 2015-153646 (laid open on Aug. 24, 2015)

### SUMMARY OF INVENTION

### Technical Problem

However, the aforementioned existing PTL 2 does not disclose the illumination shapes with respect to the emitting section 203 containing a phosphor.

Here, in general, laser light is an elliptical or circuit spot. Therefore, when the phosphor is irradiated with an elliptical spot or a circular spot, as shown in FIG. 21(a), a projection pattern is formed by connecting light emission patterns having curved portions by scanning. As a result, a boundary Hi of between a bright portion and a dark portion becomes curved. During the scanning, even a boundary B2 of a dark portion that is formed when the light source is turned off also becomes curved as shown in FIG. 21(b).

However, for vehicular headlight applications, a pattern which is light only in particular areas and which is dark in other regions is required. Here, it is desirable that the bright-dark contrast be high and a dark portion pattern be linear.

The present invention is made in view of the above-described existing problems, and it is an object of the present invention to provide an illumination device that is capable of making linearly clear a bright-dark contrast of a boundary between an illumination region and a dark portion in at least one of a horizontal direction and a vertical direction, and a vehicular headlight.

### Solution to Problem

To this end, an illumination device according to an embodiment of the present invention includes an illumination device including an emitting section having a phosphor that receives excitation light emitted from an excitation light source and emits light; and an excitation light scanning section that continuously changes a position of a spot of the excitation light on the emitting section in accordance with a predetermined rule, wherein the spot has an edge portion in which at least a pair of two opposing sides are linear.

To this end, a vehicular headlight according to an embodiment of the present invention comprises the above-described illumination device.

### Advantageous Effects of Invention

According to an embodiment of the present invention, there are provided an illumination device that is capable of making linearly clear a bright-dark contrast of a boundary between an illumination region and a dark portion in at least one of a horizontal direction and a vertical direction, and a vehicular headlight.

### BRIEF DESCRIPTION OF DRAWINGS

FIG. 1(a) is a schematic structural view of a structure of an illumination device according to a first embodiment of the present invention, FIG. 1(b) is a side view of a structure of a light guiding member of the illumination device, and FIG. 1(c) is a plan view of a residual image of a spot that has scanned and illuminated an emitting section of the illumination device.

FIG. 2 is a perspective view of a state in which an illumination region on an emitting section is changed by using a galvanometer mirror of the illumination device.

FIG. 3 is a perspective view of a state in which the illumination region on the emitting section is changed by using a polygon mirror of the illumination device.

FIG. 4 is a perspective view of a state in which the illumination region on the emitting section is changed by using an MEMS mirror of the illumination device.

FIG. 5(a) is a graph showing a relationship between driving voltage that is applied to the galvanometer mirror and the positions of a spot on the emitting section, FIG. 5(b) is a plan view of an illumination state on the emitting section when the spot on the emitting section exists at a position P1, FIG. 5(c) is a plan view of an illumination state on the emitting section when the spot on the emitting section exists at a position P2, and FIG. 5(d) is a plan view of a residual image of the spot when the spot on the emitting section continuously scans a portion from the position P1 to the position P2.

FIG. 6(a) is a plan view of a shape of a modification of a spot of the illumination device according to the first embodiment of the present invention, and FIG. 6(b) is a plan view of an illumination region when the aforementioned spot scans the emitting section.

FIG. 7(a) is a graph showing a relationship between the driving voltage that is applied to the galvanometer mirror, the positions of the spot on the emitting section, and driving current of a laser element, and FIG. 7(b) is a plan view of a residual image when continuous scanning is performed by the spot.

FIG. 8(a) is a graph showing a relationship between the driving voltage that is applied to the galvanometer mirror, the positions of the spot on the emitting section, and the driving current of the laser element, and FIG. 8(b) is a plan view of a residual image when continuous scanning is performed by the spot.

FIG. 9 is a graph showing a relationship between the driving voltage that is applied to the galvanometer mirror, the positions of the spot on the emitting section, and the driving current of the laser element.

FIG. 10(a) is a graph showing a relationship between the driving voltage that is applied to the galvanometer mirror, the positions of the spot on the emitting section, and the driving current of the laser element, and FIG. 10(b) is a plan view of a residual image when continuous scanning is performed by the spot as a result of control shown in 10(a).

FIG. 11(a) is a schematic structural view of a structure of an illumination device according to a second embodiment of the present invention, FIG. 11(b) is a side view of a structure of a light guiding member of the illumination device, and FIGS. 11(c) and 11(d) are each a plan view of a residual image of a spot that has scanned and illuminated an emitting section of the illumination device.

FIG. 12 is a perspective view of a state in which an illumination region on the emitting section is changed by using two galvanometer mirrors of the illumination device.

FIG. 13 is a perspective view of a structure of a biaxial MEMS mirror of the illumination device.

FIG. 14(a) is a graph showing a relationship between driving voltage that is applied to a galvanometer mirror and the positions of a spot on the emitting section, FIG. 14(b) is a plan view of an illumination state on the emitting section when the spot on the emitting section scans a portion from a position P1 to a position P4, and FIG. 14(c) is a plan view of a residual image of the spot when the spot on the emitting section continuously scans the portion from the position P1 to the position P4.

FIG. 15(a) is a graph showing a relationship between the driving voltage that is applied to the galvanometer mirror, the positions of the spot on the emitting section, and driving current of the laser element, and FIG. 15(b) is a plan view of a residual image of the spot when continuous scanning is performed by the spot as a result of control shown in FIG. 15(a).

FIG. 16 is a schematic structural view of a structure of an illumination device according to a third embodiment of the present invention.

FIG. 17 shows a vehicular headlight according to a fourth embodiment of the present invention, and is a conceptual view of a vehicle including the illumination device as a headlamp.

FIG. 18 is a block diagram for describing a controlling section of the vehicle.

FIG. 19 is a plan view of a projection pattern of a vehicular lighting fixture serving as an existing illumination device.

FIG. 20 is a sectional view of a structure of a vehicular lighting fixture serving as another existing illumination device.

FIGS. 21(a) and 21(b) are each a plan view of a projection pattern formed by a spot in an existing illumination device.

FIG. 22(a) shows a sectional shape of an optical fiber of an existing illumination device, and FIGS. 22(b), 22(c), and 22(d) are each a plan view of an illumination region on an emitting section.

FIGS. 23(a) and 23(b) are each a plan view of a projection pattern formed by a spot in another existing illumination device.

### DESCRIPTION OF EMBODIMENTS

### First Embodiment

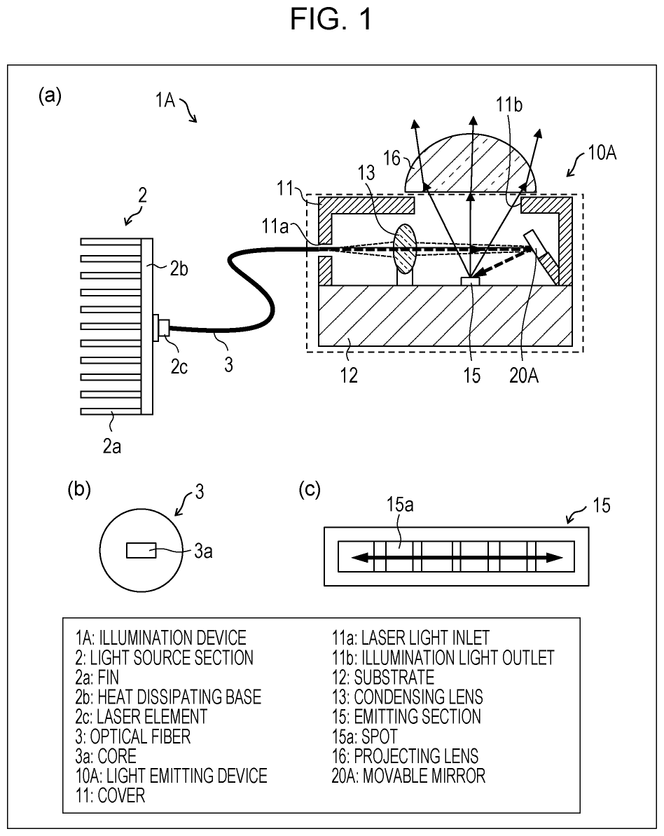

An embodiment of the present invention is described on the basis of FIGS. 1 to 10 below.

In the embodiment, an illumination device of the present invention is described when it is applied to a headlamp of an automobile, that is, a vehicular headlight. However, the illumination device according to the present invention is applicable to vehicular headlights other than those for automobiles, and is applicable to other illumination devices.

### (Structure of Illumination Device)

A structure of the illumination device of the embodiment is described on the basis of FIGS. 1(a), 1(b), and 1(c). FIG. 1(a) is a schematic structural view of the structure of the illumination device. FIG. 1(b) is a side view of a structure of a light guiding member of the illumination device. FIG. 1(c) is a plan view of a residual image of a spot that has scanned and illuminated an emitting section of the illumination device.

As shown in FIG. 1(a), the illumination device 1A of the embodiment includes a light source section 2 that includes a laser element 2c serving as an excitation light source, an optical fiber 3 that serves as a light guiding member and guides laser light, which is excitation light, emitted from the laser element 2c of the light source section 2 to a distant place, and a light emitting device 10A that applies the laser light that exits from the optical fiber 3 to an emitting section 15 via a movable mirror 20A and that causes the laser light to be reflected by the emitting section 15 and to be emitted forward.

### (Light Source Section)

The light source section 2 includes the laser element 2c mounted on a heat dissipating base 2b that is provided with fins 2a.

The laser element 2c is a light emitting element including a chip from which laser light is emitted, and functions as an excitation light source that excites a phosphor of the emitting section 15. The laser element 2c may be one having one light emitting point on one chip, or may be one having a plurality of light emitting points on one chip. A peak wavelength of the laser light that is emitted from the laser element 2c is selected from, for example, a wavelength region of a bluish violet color in a range of 380 nm to 415 nm, and is, for example, 395 nm. However, the peak wavelength of the laser light from the laser element 2c is not limited thereto, and may be selected as appropriate in accordance with the use of the illumination device 1A and the type of phosphor of the emitting section 15. For example, the laser element 2c may be one that oscillates laser light having a peak wavelength in a wavelength range of 420 nm to 490 nm, that is, in a wavelength range close to that of blue. For example, the laser element 2c may oscillate laser light having a wavelength of 450 nm.

When laser light is used as the excitation light, it is possible to efficiently excite the phosphor of the emitting section 15 than when light that is not laser light, such as light from a light emitting diode, is used By increasing the excitation efficiency, it is possible to reduce the size of the emitting section 15. Since the excitation light is laser light, it is possible to narrow an illumination region of the emitting section 15 illuminated with the excitation light. By narrowing the illumination region, it is possible to increase the resolution of an illumination pattern that is projected from the illumination device 1A. If such points are not considered, it is possible to use a different type of light emitting element, such as a light emitting diode, in place of the laser element 2c as the excitation light source.

Although, in the illumination device 1A, one laser element 2c is used, a plurality of laser elements 2c may also be used.

Next, the heat dissipating base 2b is a supporting member that supports the laser element 2c, and is a heat dissipating member that dissipates heat from the laser element 2c. Therefore, it is desirable that the heat dissipating base 2b be made of a metal having strength and thermal conductivity so as to efficiently dissipate the heat; for example, it is desirable that the heat dissipating base 2b be primarily made of aluminum, copper, or the like. The heat dissipating base 2b may be made of a material containing a material having high thermal conductivity that is not a metal (such as silicon carbide or aluminum nitride).

In order to increase the heat dissipation efficiency, the heat dissipating base 2b is provided with the fins 2a.

The fins 2a are provided on the heat dissipating base 2b on a side opposite to the side where the laser element 2c is joined. The fins 2a are a cooling mechanism, that is, a heat dissipating mechanism that dissipates the heat transmitted from the laser element 2c to the heat dissipating base 2b in order to perform cooling, and are formed from a plurality of heating dissipating plates serving as cooling plates. By forming the fins 2a from the plurality of heat dissipating plates, the contact area between the fins 2a and the atmosphere is increased. Therefore, it is possible to increase the heat dissipation efficiency of the fins 2a.

Although, in the illumination device 1A, the heat dissipating base 2h and the fins 2a are integrated with each other, they may be separately provided. For example, when they are separately provided, the heat dissipating base 2b and the fins 2a may be thermally connected via, for example, a heat pipe (a water cooling pipe or an oil cooling pipe) or a Peltier element.

Although, in the illumination device 1A, the heat dissipating base 2b is naturally cooled by means of the fins 2a formed from the heat dissipating plates, other cooling mechanisms may be used. For example, a fan or the like may be further provided to forcefully cool the heat dissipating base 2b by blowing wind against the fins 2a. Alternatively, a liquid cooling method may be used, and a radiator may be used instead of the fins 2a.

### (Optical Fiber)

Next, the optical fiber 3 is described.

The optical fiber 3 is an optical member that guides the laser light emitted from the laser element 2c to the inside of the light emitting device 10A. In the present invention, the optical fiber 3 need not be provided. That is, for example, when the distance from the laser element 2c to the movable mirror 20A or the emitting section 15 is small, a light guiding member other than the optical fiber may be used. For example, when the light source section. 2 and the light emitting device 10A are integrated with each other, it is possible to use an optical rod as the light guiding member instead of the optical fiber 3. In this case, although the light guiding member becomes relatively short, as long as a light distribution at an exiting end surface of the light guiding member has a desired rectangular shape, it is possible to obtain the effect of making a spot rectangular. It is possible to acquire a rectangular spot by means other than the light guiding member. For example, when an aperture having a rectangular opening portion is provided anywhere in an optical path up to the emitting section, it is possible to form a rectangular spot.

As shown in FIG. 1(h), as the optical fiber 3 of the embodiment, a circular fiber having a rectangular core 3a measuring, for example, 400 μm×400 μm is used. An incident end of the optical fiber 3 is an end portion upon which the laser light emitted from the laser element 2c is incident, and is optically coupled to a light emitting end surface of the laser element 2c.

It is desirable that, as the optical fiber 3, a multi-mode optical fiber be used such that unevenness in the quantity of laser light does not occur at one spot of the laser light at the emitting section 15. When the optical fiber 3 is a multi-mode optical fiber, the distribution of the laser light in the inside of the core 3a of the optical fiber 3 becomes uniform, so that the distribution of the laser light becomes a top hat type, and is not uneven.

An exiting end of the optical fiber 3 is an end portion from which the laser light emitted from the laser element 2c and guided into the optical fiber 3 exits, and is disposed at a laser light inlet 11a (described later) of the light emitting device 10A.

Since the laser light is guided by the optical fiber 3, it is possible to more freely position (including orienting) the laser element 2c and the heat dissipating base 2b with respect to a cover 11 of the light emitting device 10A. Therefore, it is easier to set the heat dissipating base 2b at a position suitable for cooling the laser element 2c.

### (Light Emitting Device)

Next, the light emitting device 10A includes a substrate 12 covered by the cover 11. Therefore, the inside of the cover 11 is hollow. A condensing lens 13, the movable mirror 20A, and the emitting section 15 are provided on the substrate 12. Therefore, the cover 11 protects the emitting section 15, the movable mirror 20A, and the condensing lens 13 from, for example, dust and dirt. Further, the cover 11 protects the emitting section 15 such that unwanted light other than the laser light that has exited from the optical fiber 3 does not enter the emitting section 15. The cover 11 has a safety measure function of preventing the laser light from entering the human eyes and a function of maximally preventing the laser light that actually is not to exit to the outside from exiting as stray light. It is desirable that at least part of the cover 11 be made of a metal so as to allow heat from the emitting section 15 to be efficiently dissipated.

The laser light inlet 11a opens in a side surface of the cover 11 on an entrance side of the laser light from the laser element 2c. An illumination light outlet 11b opens above the emitting section 15. A projecting lens 16 is provided so as to cover the illumination light outlet 11b of the cover 11.

The condensing lens 13 is a lens that converges the laser light that has exited from the exiting end of the optical fiber 3. Therefore, in the illumination device 1A, the laser light emitted from the laser element 2c enters the inside of the cover 11 from the laser light inlet 11a via the optical fiber 3, is converged by the condensing lens 13, is reflected by the movable mirror 20A, and illuminates the emitting section 15.

In the illumination device 1A, the condensing lens 13 is provided for causing one side of a spot of the laser light on the emitting section. 15 to be on the order of 0.4 mm. However, the condensing lens 13 need not be provided when the laser light does not spread very much at a portion extending from the laser element 2c to the emitting section 15, or when a spot 15a of the laser light may be large on the emitting section 15. In order to adjust the size and the scanning speed of the spot 15a of the laser light on the emitting section 15, for example, a lens and a mirror may be provided as appropriate between the laser element 2c and the emitting section 15 instead of the condensing lens 13. More specifically, for example, a collimator lens may be disposed following the exiting end of the optical fiber 3, or the condensing lens may be disposed following the movable mirror 20A. Such an optical system is designed by considering, for example, the laser light density resistance at the movable mirror 20A, the emitting section 15, etc., the size of the device, and the deflection angle of the movable mirror 20A.

The emitting section 15 has a phosphor that receives the laser light emitted from the laser element 2c, and emits fluorescence. More specifically, examples of the emitting section 15 include a sealing-type emitting section in which a phosphor is scattered in the interior of a sealing material, a crystal-type emitting section in which a phosphor is solidified and a thin-film-type emitting section in which phosphor particles are applied to, that is, accumulate on a substrate made of a material having high thermal conductivity. It can be said that the emitting section 15 is also a wavelength converting element for converting the laser light into fluorescence.

As shown in FIG. 1(a), in the emitting section 15 of the embodiment, a surface thereof upon which primarily the excitation light is incident and a surface thereof from which primarily the fluorescence is emitted to the outside are the same surface. The structure of such an emitting section is called a reflecting-type emitting section. When the emitting section 15 is a reflecting type, the reflecting-type emitting section allows the fluorescence to be extracted from the surface upon which the excitation light is incident, that is, the surface where the light density of the excitation light is the highest. Therefore, the emission efficiency is high. In the reflecting-type emitting section 15, it is possible to use, for example, a metal substrate (not shown) or a highly thermally conductive ceramic substrate (not shown), which supports the emitting section 15, as a heat sink. Heat generated by the excitation of the light emitting section by the laser light can be effectively dissipated.

In order to prevent deterioration of the emitting section 15 caused by the application of laser light, it is desirable that a portion of the emitting section 15 containing the phosphor be formed so as not to contain an organic substance.

Here, the phosphor of the emitting section 15 of the embodiment is described in detail.

In the embodiment, in order to cause white fluorescence to be emitted when Laser light having a wavelength of 395 nm and oscillated by the laser element. 2c is received, as the phosphor of the emitting section 15, for example, HAM (BaMgAl₁₀O₁₇:Eu), BSON(Ba₃Si₆O₁₂N₂:Eu), or Eu-α(Ca-α-SiAlON:Eu) is used. However, the phosphor is not limited thereto, and may be selected as appropriate from any substances as long as the illumination light that is projected from the illumination device 1A is white light. Alternatively, the phosphor may be selected as appropriate so as to have a accordance with the use of the illumination device 1A.

For example, other oxynitride phosphors (for example, sialon phosphors such as JEM(LaAl(SiAl)₆N₉O:Ce) and β-SiAlON), other nitride phosphors (such as CASN(CaAlSiN₃:Eu) phosphor and SCASN((Sr,Ca)AlSiN₃:Eu), Apataite((Ca, Sr)₅(PO₄)₃Cl:Eu) based phosphors, and group III-V compound semiconductor nanoparticle phosphors (such as indium phosphide: InP) may be used.

When the laser element 2c oscillates laser light having a wavelength close to that of blue, if a yellow phosphor (such as a Yttrium-Aluminum-Garnet based phosphor activated by Ce (YAG:Ce phosphor)) is used, white light (so-called pseudo white light) is acquired. In this case, it is desirable that the emitting section 15 contain a scatterer that scatters the laser light).

As the scatterer, particles of, for example, titanium oxide (TiO₂), fumed silica-alumina (Al₂O₃), zirconium oxide (ZrO₂), or diamond (C) may be used. Alternatively, other types of particles may be used.

In the embodiment, the size of the entire emitting section 15 is, for example, 10 mm×10 mm, and a range in which the laser light for the emitting section 15 is applied (scans) is, for example, approximately 0.4 mm×10 mm. However, the size and range are not limited thereto, and are selectable as appropriate in accordance with, for example, the use of the illumination device 1A. In the embodiment, as shown in FIG. 1(c), the shape of the spot 15a on the surface of the emitting section 15 upon which the laser light is incident is rectangular. More specifically, the spot 15a has edge portions, each being such that at least a pair of two opposing sides are linear. It is desirable that the spot 15a have a rectangular shape in which two pairs of two opposing sides are linear.

That is, for vehicular headlight applications, it is desirable that the headlight does not illuminate a driver of an oncoming vehicle. Therefore, it is desirable that boundaries in a vertical direction be linear. In a non high beam state, it is desirable that an upper boundary be linear.

“Edge portions of the spot. 15a are linear” means that each edge portion has a shape that extends along a straight line serving as a reference (reference straight line), and includes a case in which each edge portion is linear and a case in which each edge portion has a gently wavy shape with the reference straight line as a central axis.

Next, a sealing material when the emitting section 15 is a sealing-type emitting section in which the phosphor is scattered in the sealing material is described in detail.

When the emitting section 15 is a sealing-type emitting section, the sealing material that seals in the phosphor may be, for example, a glass material, such as inorganic glass or organic-inorganic hybrid glass, or a resin material, such as silicone resin. As a glass material, low-melting-point glass may also be used. It is desirable that the sealing material be highly transparent, and, when the output of laser light is high, be highly resistant to heat. A structure in which the sealing is performed by using silicon oxide or titanium oxide as a result of performing a sol-gel method may also be used. It is desirable that a reflection prevention structure that prevents the reflection of laser light be formed at the incident surface (the surface upon which the laser light is incident) of the emitting section 15.

When the emitting section 15 is a sealing-type emitting section that seals in the phosphor, since it is easy to control the surface shape of the emitting section 15, it is easy to form a reflection prevention film on the incident surface of the emitting section 15.

Next, a case in which the emitting section 15 is thin-film-type emitting section in which phosphor particles are applied to, that is, accumulate on a substrate made of a material having high thermal conductivity is described in detail.

When the emitting section 15 is a thin-film-type emitting section, aluminum (Al), copper (Cu), aluminum nitride (AlN) ceramic, silicon carbide (SiC) ceramic, aluminum oxide (Al₂O₃), or silicon (Si) is used for the substrate. After applying the phosphor particles to the substrate or causing the phosphor particles to accumulate on the substrate, the substrate is divided with a desired size into substrates.

It is desirable that, when Al or Cu is used for the substrate where a thin film of phosphor is formed, apply, as a barrier metal, titanium nitride (TiN), titanium (Ti), tungsten nitride (TaN), tungsten (Ta), or the like, to a side of the substrate where the phosphor particles do not accumulate, that is, a side of the substrate opposite to a side where a thin film of the phosphor is formed. Further, Pt or Au may be applied to the barrier metal.

Next, a case in which the emitting section 15 is a crystal-type emitting section in which a phosphor is solidified is described in detail.

When the emitting section 15 is a crystal-type emitting section, a plate-shaped phosphor (a small-void-type phosphor member, more specifically, a small-void-type phosphor plate) having a small void formed in the phosphor and having a width that is less than or equal to 1/10 of the wavelength of visible light may be used as the emitting section 15. More specifically, the void width may be in a range of 0 nm to 40 nm. A void width of 0 nm means that a void does not exist. Examples of such a phosphor include a monocrystalline body, a polycrystalline body, and a sintered body.

Next, the movable mirror 20A is described. The movable, mirror 20A is a movable mirror for changing the illumination position of the laser light applied to the emitting section 15. The movable mirror 20A functions as an excitation light scanning section that continuously changes the position of the spot 15a of the laser light on the emitting section 15 of the present invention in accordance with a predetermined rule.

Here, in the embodiment, a galvanometer mirror 21 may be used as the movable mirror 20A. The galvanometer mirror 21 is described on the basis of FIG. 2. FIG. 2 is a perspective view of a state in which an illumination region on the emitting section 15 is changed by using the galvanometer mirror 21.

As shown in FIG. 2, the galvanometer mirror 21 serving as the movable mirror 20A is a movable mirror for changing the illumination position of the laser light applied to the emitting section 15, and is one in which a plane mirror 21b mounted on a uniaxial galvanometer mechanism 21a rotates. The rotation angle of the plane mirror 21b changes in accordance with a driving voltage that is applied to the galvanometer mechanism 21a. Therefore, it is possible to easily control the illumination post ion of the laser light applied to the emitting section 15 by using a simple circuit. That is, it is easy to scan the illumination surface of the emitting section 15.

As shown in FIG. 2, by applying a predetermined driving voltage to the galvanometer mechanism 21a, the plane mirror 21b is capable of reflecting the laser light at a predetermined angle. Therefore, an optical path of the laser light reflected by the plane mirror 21b is changed by rotating the plane mirror 21b, so that the illumination position of the laser light applied to the emitting section 15 is changed in a left-right direction (x directions or horizontal directions).

In order to increase the reflectivity of the laser light and prevent deterioration caused by the laser light, in the embodiment, the plane mirror 21b is coated with, for example, a (HR: High Reflect) coating. The HR coating is a dielectric multilayer film, and is adjusted such that the reflectivity becomes high at the wavelength of the laser light from the laser element 2c. Not only is the plane mirror 21b coated with the HR coating, but also the condensing lens 13 and the projecting lens 16 are also each coated with an (AR: Anti Reflect) coating in the embodiment in order to prevent deterioration caused by the laser light.

Although, in the description above, the galvanometer mirror 21 is used as the movable mirror 20A for changing the optical path of the laser light and changing the illumination position of the laser light applied to the emitting section 15, the movable mirror 20A is not limited thereto, so that other movable optical elements may be used. For example, a polygon mirror, a movable curved surface mirror, an MEMS (micro electro mechanical system) mirror in which very small mechanical components and electrical circuits are merged, a piezo element mirror, or an acoustooptic element may be used.

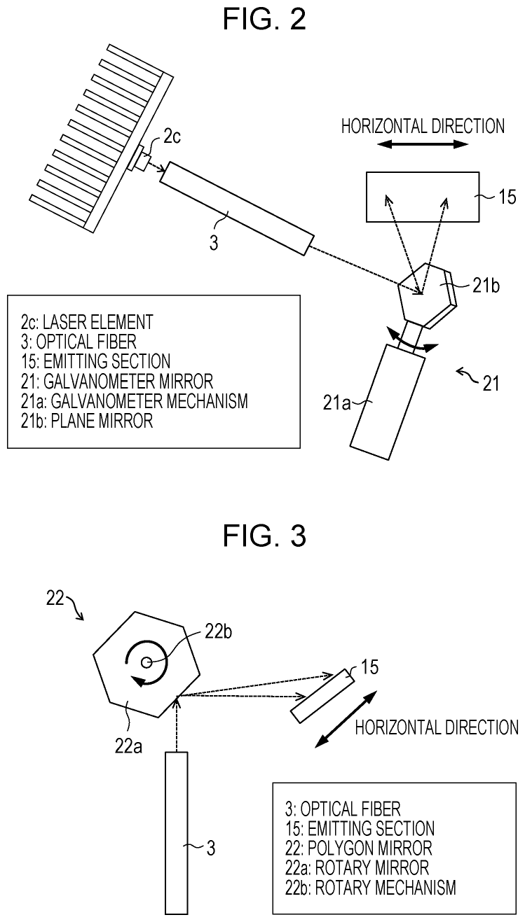

As a modification of the movable mirror 20A, a polygon mirror 22 serving as the movable mirror 20A is described below on the basis of FIG. 3. FIG. 3 is a perspective view of a state in which an illumination region on the emitting section 15 is changed by using the polygon mirror 22.

As shown in FIG. 3, the polygon mirror 22 is a rotary polygon mirror that reflects laser light while rotating around a rotation axis as a center. In the polygon mirror 22, a rotary mirror 22a is connected to a rotary mechanism 22b that rotates the rotary mirror 22a. Since an optical path of the laser light reflected by the polygon mirror 22 is changed by rotating the rotary mechanism 22b at the rotary mirror 22a, an illumination position of the laser light applied to the emitting section 15 is changed in the left-right directions (the x directions or the horizontal directions). In this way, in the polygon mirror 22, the rotary mirror 22a and the rotary mechanism 22b constitute an illumination position changing section.

In this case, since the rotary mechanism 22b generally rotates at a constant angular velocity, that is, undergoes equiangular rotation, it is desirable that a so-called Fθ lens be inserted between the polygon mirror 22 and the emitting section 15 such that the laser light scans the emitting section 15 with a constant velocity instead of with an equal angle. The Fθ lens is a lens or a lens group that is adjusted so as to focus an image having a size (f·θ), which is the product of an incident angle θ of laser light and a focal length f.

As with the plane mirror 21b, the polygon mirror 22 of the embodiment is coated with an HR coating for increasing the reflectivity of the laser light and to prevent deterioration caused by the laser light.

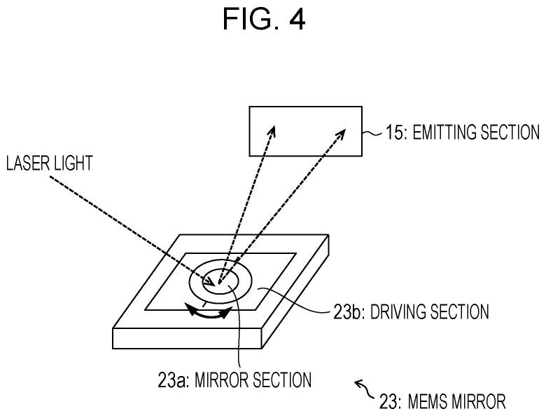

As still another modification of the movable mirror 20A, an MEMS mirror 23 serving as the movable mirror 20A is described on the basis of FIG. 4. FIG. 4 is a perspective view of a state in which an illumination region on the emitting section 15 is changed by using the MEMS mirror 23.

As shown in FIG. 4, the MEMS mirror 23 includes a mirror section 23a that reflects laser light, and a driving section 23b that rotates the mirror section 23a. Since the angle of the mirror section 23a with respect to the driving section 23b is changed due to a driving voltage that is applied to the driving section 23h, an optical path for the laser light reflected by the mirror section 23a is changed. Therefore, the illumination position of the laser light applied to the emitting section 15 is changed in the left-right directions (the x directions or horizontal directions). As the MEMS mirror 23, a resonance-type MEMS mirror that is capable of increasing scanning speed, or a non-resonance-type MEMS mirror may be used.

Next, the projecting lens 16 of the light emitting device 10A shown in FIG. 1(a) is described.

The projecting lens 16 is a projecting convex lens that passes the fluorescence emitted from the emitting section. 15 and projects the light to the outside of the illumination device 1A. The projecting lens 16 may project laser light scattered by the emitting section and the fluorescence emitted by the emitting section 15. The projecting lens 16 is disposed so as to oppose an exiting surface of the emitting section 15 from which the fluorescence is emitted. The projecting lens 16 refracts illumination light emitted from the emitting section 15 to project the light in a predetermined angle range. This makes it possible to project the light emitted from the emitting section 15 to be projected to the outside from the projecting lens 16.

As a projecting section that projects the light emitted from the emitting section 15, instead of the projecting lens 16, it is also possible to use a concave mirror, that is, reflector that reflects the illumination light emitted from the emitting section 15 and projects the illumination light to the outside of the illumination device 1A. It is desirable that the reflector be, for example, a parabolic mirror in which a parabolic curved surface that is formed by rotating a parabola with a symmetrical axis of the parabola as a rotation axis includes a reflecting curved surface. In this case, by the reflector, the illumination light emitted from the emitting section 15 is formed into a bundle of rays that are nearly parallel and projected from an opening portion of the projecting section. This makes it possible to efficiently project the light emitted from the emitting section 15 within a narrow solid angle.

Alternatively, the projecting section may be a combination of a plurality of projecting lenses, or may be a combination of a projecting lens and a reflector.

### (Illumination Region of Spot on Emitting Section)

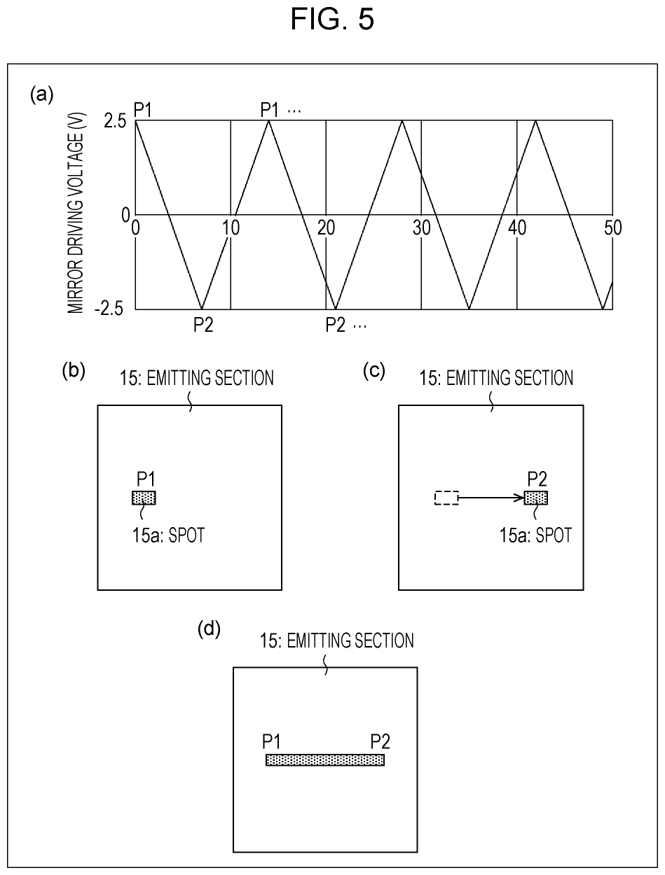

Next, an illumination region of the spot 15a on the emitting section 15 of the embodiment is described on the basis of FIGS. 5(a), 5(b), 5(c), and 5(d). Here, the galvanometer mirror 21 serving as the movable mirror 20A is used to describe the illumination region. FIG. 5(a) is a graph showing a relationship between driving voltage that is applied to the galvanometer mirror 21 and the positions of the spot 15a on the emitting section 15. The horizontal axis indicates the time in msec (milliseconds). The vertical axis indicates the driving voltage, with an upper side being + (plus) and a lower side being − (minus). FIG. 5(b) is a plan view of an illumination state on the emitting section 15 when the spot 15a on the emitting section 15 exists at a position P1. FIG. 5(c) is a plan view of an illumination state on the emitting section 15 when the spot 15a on the emitting section 15 exists at a position P2. A. 5(d) is a plan view of a residual image of the spot. 15a when the spot 15a on the emitting section 15 continuously scans a portion from the position P1 to the position P2.

As shown in FIG. 5(a), by applying a driving voltage of a triangular wave with a frequency of 71.4 Hz (a period of 14 msec) from plus to minus to the galvanometer mechanism 21a of the galvanometer mirror 21, the plane mirror 21b undergoes reciprocating rotation. In the embodiment, when the driving voltage that is applied to the galvanometer mechanism 21a is a maximum value of, for example, +2.5 V, the spot 15a of laser light is positioned at the position P1, shown in FIG. 5(b), on the emitting section 15. On the other hand, when the voltage that is applied to the galvanometer mechanism. 21a is a minimum value of, tar example, −2.5 V, the spot of the laser light is positioned at the position P2, shown in FIG. 5(b), on the emitting section 15. Therefore, due to the reciprocating rotation of the plane mirror 21b, the spot 15a of the laser light on the emitting section 15 undergoes a reciprocating linear motion between the positions P1 and P2 at a speed of 14 msec for one reciprocation as shown in FIG. 5(c), to form the illumination region, that is, a laser-light scanning region.

In the embodiment, since the size of the spot 15a is 0.4 mm×0.4 mm, the size of the illumination region is approximately 0.4 mm×10 mm. However, the size is not limited thereto. By changing the setting of the maximum and minimum values of the voltage that is applied to the galvanometer mechanism 21a, it is possible to increase and decrease the length of the illumination region. By changing the diameter of the spot 15a of the laser light on the emitting section 10, it is possible to increase and decrease the thickness of the illumination region. The reciprocation speed of the laser light is not limited to the aforementioned speed. By changing the frequency (period) of the voltage that is applied to the galvanometer mechanism 21a, it is possible to increase and decrease the reciprocation speed.

Light from the emitting section 15 that has received the laser light and has emitted the light is projected by the projecting lens 16, and a projected illumination pattern corresponds to the spot 15a of the laser light on the emitting section 15. When the spot of the laser light moves at a sufficient speed, due to a residual image effect, she illumination pattern is seen by the human eyes as if the entire illumination region between the position P1 and the position P2 is illuminated with the laser light as shown in FIG. 5(c). In the illumination device 1A, the illumination pattern is a linear (one-dimensional) pattern. However, even in an illumination device where an illumination pattern is a planar (two-dimensional) pattern, similarly, if the emitting section 15 is scanned with laser light at a sufficient speed, due to the residual image effect, the human eyes do not sense flickering caused by the scanning. An illumination device 1B where an illumination pattern is a planar (two-dimensional) pattern is described in a second embodiment.

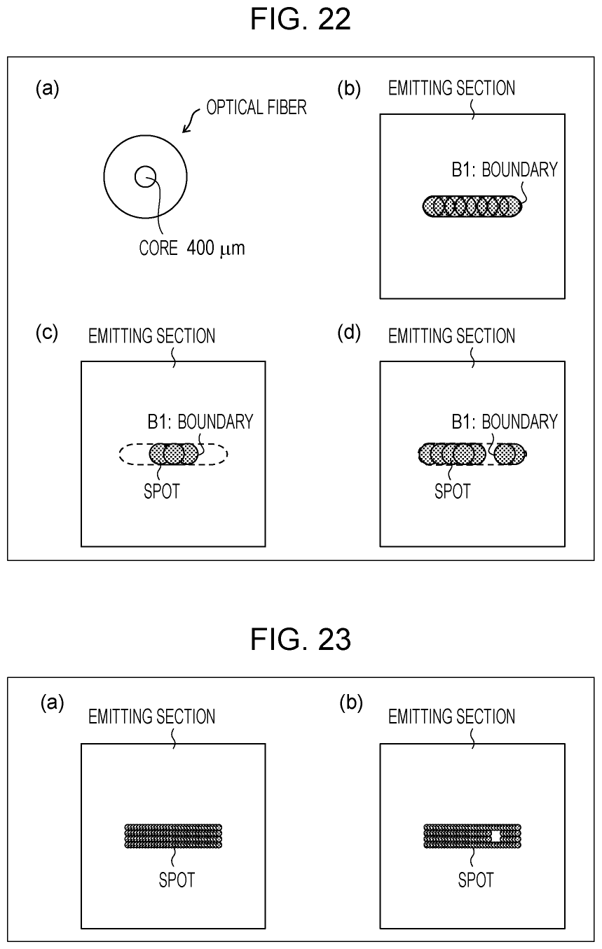

Hitherto, as shown in FIG. 22(a), since, in general, laser light is an elliptical or a circular spot, when the emitting section is scanned and illuminated with an elliptical or circular spot such that a residual image remains, as shown in FIGS. 22(b) and 22(c), a boundary B1 on two sides between a location where the spot is applied and a location where the spot is not applied becomes curved. During the scanning, as shown in FIG. 22(d), a boundary 52 of a dark portion that is formed when the light source is turned off also becomes curved.

However, for vehicular headlight applications, a pattern where only a particular area is bright and areas other than the particular area are dark is required. Here, it is desirable that the bright-dark contrast be high, and a dark portion pattern be a linear pattern.

Therefore, as shown in FIGS. 5(b) and 5(c), the spot 15a of the embodiment has a rectangular shape in which two pairs of two opposing sides are linear. In the embodiment, the shape of the spot 15a can be provided by forming the core 3a of the optical fiber 3 with a rectangular shape.

As a result, as shown in FIG. 1(c), when the emitting section is scanned such that a residual image remains, at a boundary between the location where the spot 15a is applied and the location where the spot 15a is not applied, a bright portion and the dark portion become linear.

As a result, in the illumination device 1A of the embodiment, an appropriate spot 15a for vehicular headlight applications is provided.

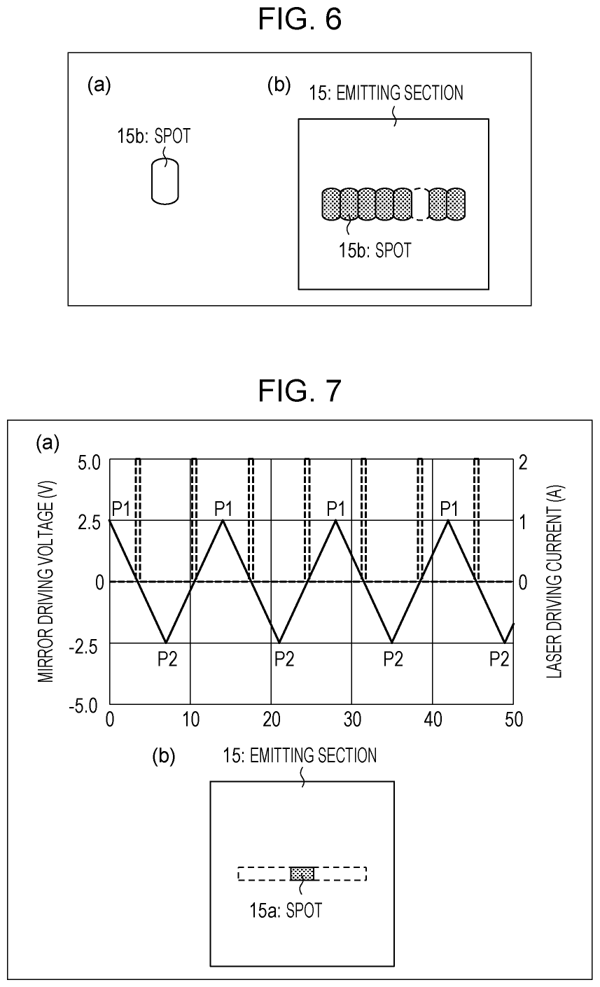

Here, the shape of the spot 15a of the embodiment is not necessarily limited to a rectangular shape. That is, as shown in FIGS. 6(a) and 6(b), a spot 15b having edge portions, each being such that a pair of two opposing sides in a vertical direction are linear, may be used. Therefore, when the core 3a having opposing linear portions in the vertical direction is used, it is possible to provide a clear contrast in the vertical direction that is required the most by the vehicular headlight. However, since peripheral portions of the upper and lower sides do not become linear, the effect is less than that provided by the rectangular shape.

Here, in the foregoing description, the laser element 2c is driven by a certain current, but is not limited thereto. In synchronism with the movement of the galvanometer mirror 21, the laser element 2c may be turned on and off or the intensity may be modulated to control a projection pattern.

A method of controlling a projection pattern when the laser element. 2c is turned on and off in synchronism with the movement of the galvanometer mirror 21 is described on the basis of FIGS. 7(a) and 7(b). FIG. 7(a) is a graph showing a relationship between the driving voltage that is applied to the galvanometer mirror 21, the positions of the spot 15a on the emitting section 15, and driving current of the laser element 2c The horizontal axis indicates the time in msec (milliseconds). The vertical axis indicates the driving voltage, with an upper side being + (plus) and a lower side being − (minus). The solid line indicates the driving voltage that is applied to the galvanometer mirror 21, and the broken lines indicate the driving current of the laser element 2c. FIG. 7(b) is a plan view of a residual image of the spot 15a when continuous scanning is performed by the spot 15a as a result of control shown in FIG. 7(a).

As shown in FIG. 7(a), for example, when the driving voltage that is applied to the galvanometer mirror 21 becomes 0 V, the driving current of the laser element 2c is turned on. This causes a projection pattern that shines only at the center of the emitting section 15 to be acquired as shown in FIG. 7(b). By changing the time width in which the driving current of the laser element 2c is turned on, it is possible to change the width of a light emission region. Further, by changing the timing in which the driving current of the laser element 2c is turned on, it is possible to change a light emission position on the emitting section 15.

In FIG. 7(a), when the driving current of the laser element 2c is turned off, the current is set completely at 0 A. However, if a desired bright-dark contrast can be acquired, the current need not be set completely at 0 A. For example, if the current is less than or equal to a threshold current, it is possible to provide a dark portion even if the current is not set completely at 0 A. Although it is desirable that she current be 0 A in terms of electric power and contrast, it is possible provide a dark portion when applying a bias current for stabilizing a pulse waveform or increasing the modulation speed.

In FIG. 7(a), the driving current of the laser element 2c is modulated with the waveform being that of a rectangular wave. However, when the waveform of the driving current of the laser element 2c is, for example, a sinusoidal-wave waveform, a waveform based on Gaussian distribution, or a waveform based on Lorentz distribution, instead of the rectangular-wave waveform, it is possible to realize a projection pattern whose brightness changes in gradations. A pattern in which the number of on locations is more than one and the plurality of locations emit light nay also be used.

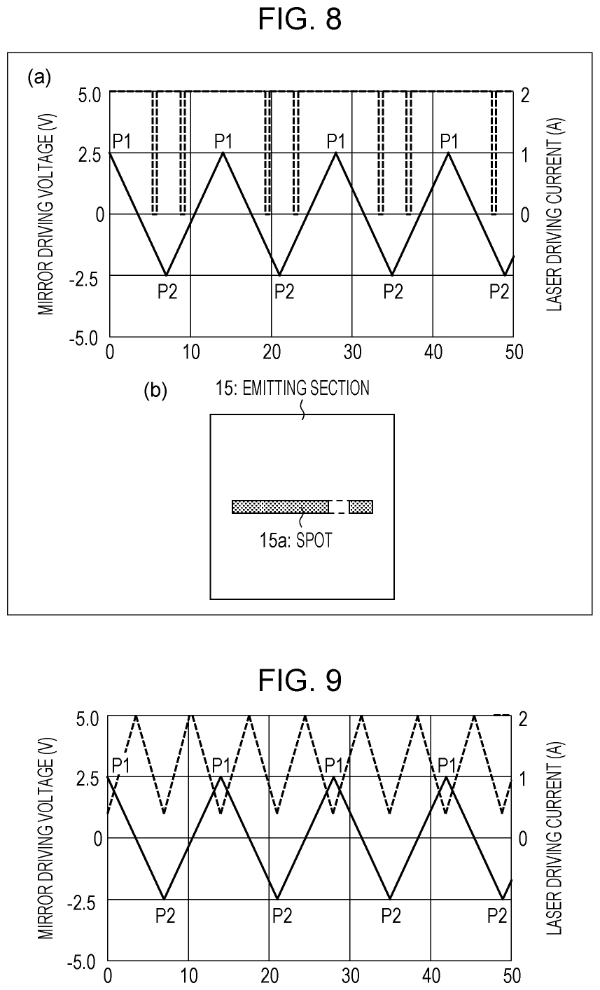

Another method of controlling a projection pattern when the driving current of the laser element 2c is modulated in synchronism with the movement of the galvanometer mirror 21 is described on the basis of FIGS. 8(a) and 8(b). FIG. 8(a) is a graph showing a relationship between the driving voltage that is applied to the galvanometer mirror 21, the positions of the spot 15a on the emitting section 15, and the driving current of the laser element 2c. The horizontal axis indicates the time in msec (milliseconds). The vertical axis indicates the driving voltage, with an upper side being + (plus) and a lower side being − (minus). The solid line indicates the driving voltage that is applied to the galvanometer mirror 21, and the broken lines indicate the driving current of the laser element 2c. FIG. 8(b) is a plan view of a residual image of the spot 15a when continuous scanning is performed by the spot 15a as a result of control shown in FIG. 8(a).

As shown in FIG. 8(a), when the driving voltage that is applied to the galvanometer mirror 21 becomes −1.25 V, the driving current of the laser element 2c is turned off. Therefore, as shown in FIG. 8(b), a projection pattern in which only a portion of the emitting section 15 that is situated on the right of the center of the emitting section 15 does not shine is acquired. By changing the time width in which the driving current of the laser element 2c is turned off, it is possible to change the width of a light non-emission region. Further, by changing the timing in which the driving current of the laser element 2c is turned off, it is possible to change the light non-emission position.

In FIG. 8(a), the driving current of the laser element 2c is modulated with the waveform being that of a rectangular wave. However, when the waveform of the driving current of the laser element 2c is, for example, a sinusoidal-wave waveform, a waveform based on Gaussian distribution, or a waveform based on Lorentz distribution, instead of the rectangular-wave waveform, it is possible to realize a projection pattern whose darkness changes in gradations. A projection pattern in which the number of off locations of the driving current of the laser element 2c is more than one and the plurality of locations do not emit light may also be used.

For example, as shown in FIG. 9, the driving current of the laser element 2c is modulated with the waveform being that of a triangular wave. Therefore, it is possible so form a projection pattern in which the central portion of the emitting section 15 is the brightest and the brightness gradually decreases towards both sides. Although, in FIG. 9, the driving current of the laser element 2c changes linearly, the driving current is not necessarily limited thereto. The driving current may have a sinusoidal waveform, a waveform based on Gaussian distribution, or a waveform based on Lorentz distribution. The pattern in which the central portion of the emitting section 15 is the brightest is suitably used as a high beam in a vehicular headlight.

Here, in the foregoing description, in order for the spot 15a to be such that a portion of the illumination region is a non-lighting region, the driving current of the laser element 2c is turned off, but is not limited thereto. It is possible to, with the driving current of the laser element 2c being constant, form a non-lighting region in a portion of the illumination region by changing the scanning speed of the spot 15a.

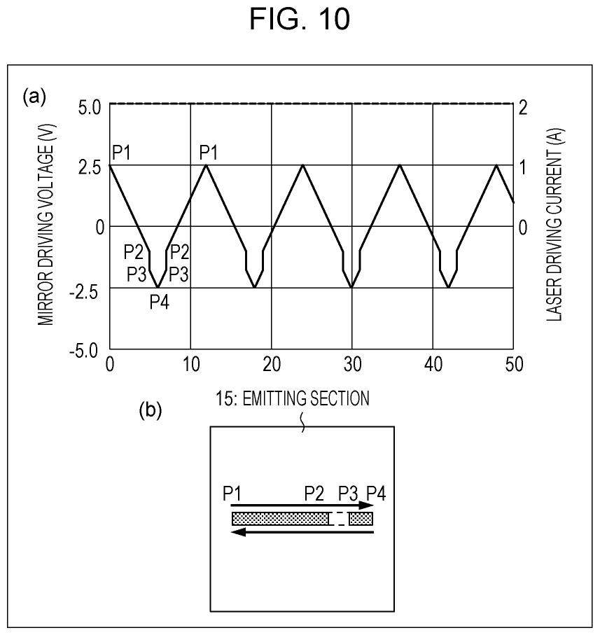

A method of, with the driving current of the laser element 2c being constant, forming a non-lighting region in a portion of the illumination region changing the scanning speed of the spot 15a is described on the basis of FIGS. 10(a) and 10(b). FIG. 10(a) is a graph showing a relationship between the driving voltage that is applied to the galvanometer mirror 21, the positions of the spot 15a on the emitting section 15, and the driving current of the laser element 2c. The horizontal axis indicates the time in msec (milliseconds). The vertical axis indicates the driving voltage, with an upper side being + (plus) and a lower side being − (minus). The solid line indicates the driving voltage that is applied to the galvanometer mirror 21, and the broken lines indicate the driving current of the laser element 2c. FIG. 10(b) is a plan view of a residual image of the spot 15a when continuous scanning is performed by the spot. 15a as a result of control shown in 10(a).

As shown in FIG. 10(a), when the driving voltage that is applied to the galvanometer mirror 21 is decreased from +2.5 V at uniform speed, and the driving voltage that is applied to the galvanometer mirror 21 becomes, for example, −1.1 V, the driving voltage is rapidly decreased up to, for example, −1.8 V. Then, the original constant speed is maintained from the driving voltage of −1.8 V to a driving voltage of −2.5 V.

In this case, as shown in FIG. 10(b) the spot 15a on the emitting section 15 is such that a portion extending from a position P1 to a position P2 is a bright region. However, when the driving voltage is rapidly decreased from −1.1 V to −1.8 V, a residual image does not remain in a portion extending from the position P2 to a position P3, which is an illumination region, during this time. Then, thereafter, by scanning a portion extending from the position P3 to a position P4 with the original uniform speed being maintained, the bright portion is restored. As a result, the portion extending from the position P2 to the position P3 is a Light non-emission region.

In this way, even if the laser element 2c continues to be turned on, by increasing the scanning speed, the change occurs at a speed that cannot be followed by the human eyes. As a result, the area appears to be a dark portion.

In this controlling method, the laser element 2c need not be turned on and off. As a result, it is possible for the driving circuit of the laser element 2c to be a simple driving circuit, so that it is possible to increase the reliability, reduce the cost, and reduce the size of the illumination device 1A.

For example, as a different method of providing linearity, a method of performing more precise scanning by using a smaller spot can be considered as shown in FIGS. 23(a) and 23(h). However, in this case, the control becomes complicated and it becomes difficult to precisely focus an image on the emitting section.

In the illumination device 1A according to the embodiment, it is possible so acquire a linear boundary between a bright and a dark portion without reducing the size of the spot 15a and without increasing the precision of the scanning.

As such a related art example, for example, in a vehicular headlight in PTL 3, scanning is performed at a very high speed and with very high precision compared to that in the illumination device 1A of the embodiment in which an MEMS mirror is used and the frequency is 24 kHz in the horizontal direction. However, in this case, the laser element needs to be turned on and off at a very high speed. Since the laser element 2c is driven with a high current of 1 A to 3 A, it is difficult to turn the laser element 2c on and off at such a high speed. The illumination device 1A of the embodiment has an advantage in that a projection pattern can be formed by a relatively slow on-off control of the driving current of the laser element 2c.

In this way, the illumination device 1A of the embodiment includes the emitting section 15 having a phosphor that receives excitation light emitted from the laser element 2c, serving as an excitation light source, and that emits light; and the movable mirror 20A, serving as an excitation light scanning section, that continuously changes the position of the spot 15a or the spot 15b of the excitation light on the emitting section 15 in accordance with a predetermined rule. The spots 15a and 15b have edge portions, each being such that at least a pair of two opposing sides are linear.

Therefore, at a boundary between a bright portion and a dark portion, it is possible for at least a pair of two opposing sides to be linear.

Consequently, it is possible to provide the illumination device 1A that is capable of making linearly clear the bright-dark contrast of a boundary between a bright portion, which is an illumination region, and a dark portion in at least one of the horizontal direction and the vertical direction.

In the illumination device 1A of the embodiment, it is desirable that the spot 15a have a rectangular shape in which two pairs of two opposing sides are linear.

This makes it possible to provide the illumination device 1A that is capable of making linearly clear the bright-dark contrast of a boundary between a bright portion, which is an illumination region, and a dark portion in both the horizontal direction and the vertical direction.

In the illumination device 1A of the embodiment, it is desirable that the light intensity in the spot 15a or 15h of the excitation light of the emitting section 15 applied from the laser element 2c be constant.

This makes it possible to provide an illumination region in which the light intensity in the spot 15a or 15b on the emitting section 15 is uniform.

In the illumination device 1A of the embodiment, it is desirable that the excitation light from the laser element 2c illuminate the emitting section 15 via the optical fiber 2, serving as the light guiding member, and the light distribution of the excitation light at the exiting end surface of the optical fiber 3 is reflected in the light distribution of the spot 15a or 15h of the excitation light on the emitting section 15.

Therefore, when the distance from the laser element 2c to the emitting section 15 is large, by using the optical fiber 3 and by causing the light distribution of the excitation light at the exiting end surface of the optical fiber 3 to be reflected in the light distribution of the spot 15a or 15b of the excitation light on the emitting section 15, it is possible to illuminate the emitting section 15 with the spot 15a or 15b without reducing the light intensity of the excitation light from the laser element 2c.

In the illumination device 12 of the embodiment, the light guiding member may include an optical rod or the optical fiber 3 having the core 3a having a rectangular cross section.

By this, since the rectangular cross section of the excitation light that exits from the core 3a is reflected at the emitting section 15, it is possible to efficiently illuminate the emitting section 15 with the rectangular spot 15a or 15b.

In the illumination device 1A of the embodiment, the optical fiber 3 may be formed from a multi-mode fiber.

By this, since the distribution of the laser light in the inside of the core 3a of the optical fiber 3 is uniform, the distribution of the laser light is a top-hat type distribution, and is not uneven. In addition, the light Intensity at an on-off boundary becomes steep.

In the illumination device 1A of the embodiment, it is desirable that the excitation light scanning section include the movable mirror 20A.

This makes it possible to, by the movable mirror 20A, efficiently and continuously change the position of the spot 15a or 15b of the excitation light on the emitting section 15 in accordance with a predetermined rule.

In the illumination device 1A of the embodiment, the movable mirror 20A allows the scanning speed of the spot 15a or 15b to change.

By this, even if the laser element 2c is not turned on and off, it is possible to partly form a dark portion by, for example, increasing the scanning speed of the spot 15a or 15h when the position of the spot 15a or 15b of the excitation light on the emitting section 15 is continuously chanced in accordance with a predetermined rule.

### Second Embodiment

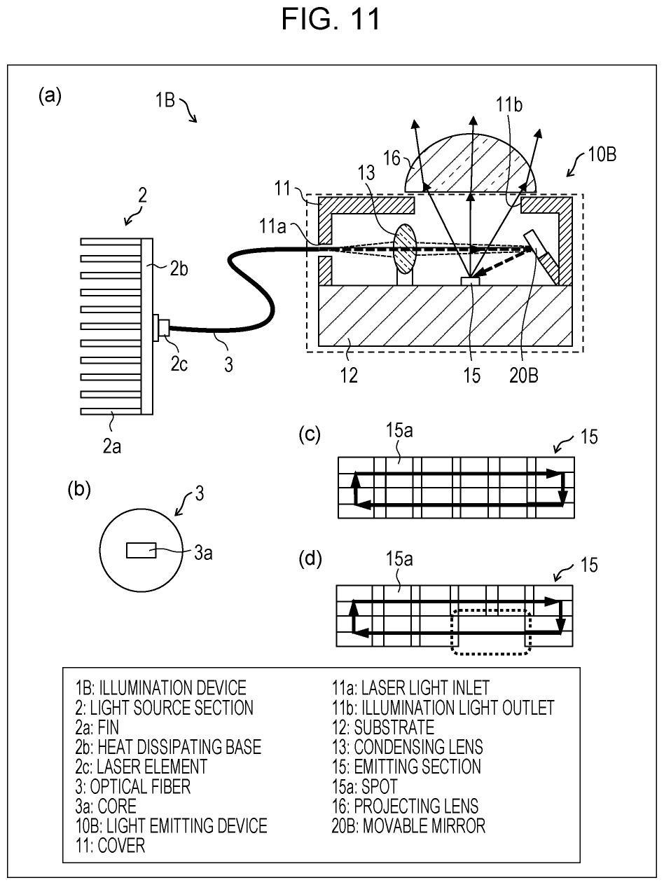

Another embodiment of the present invention is described on the basis of FIGS. 11 to 16 below. Structures other that those described in this embodiment are the same as those of toe first embodiment. For the purpose of illustration, members having the same functions as those shown in the figures for the first embodiment are given the same reference numerals and are not described below.

In the illumination device 1A of the first embodiment, the movable mirror 20A rotates uniaxially to move the spot 15a one-dimensionally. In contrast, in an illumination device 1B of this embodiment, a movable mirror 200 rotates biaxially to move the spot 15a two-dimensionally.

### (Structure of Illumination Device)

A structure of the illumination device 1B of the embodiment is described on the basis of FIGS. 11(a), 11(b), 11(c), and 11(d). 11(a) is a schematic structural view of the structure of the illumination device 1B. FIG. 11(b) is a side view of a structure of an optical fiber 3 of the illumination device 10. FIGS. 11(c) and 11(d) are each a plan view of a residual image of a spot that has scanned and illuminated an emitting section 15 of the illumination device 1B. In the description, portions that differ from those of the illumination device 1A of the embodiment are primarily described.

As shown in FIG. 11(a), the illumination device 1B of the embodiment includes a light emitting device 10B in which laser light that exits from the optical fiber 3 illuminates the emitting section 15 via the movable mirror 20B, is reflected by the emitting section 15, and exits forwardly.

### (Movable Mirror)

In the movable mirror 20B mounted on the light emitting device 108 of the illumination device 1B of the embodiment, a biaxial galvanometer mirror 24 is used by using two galvanometer mirrors 21.

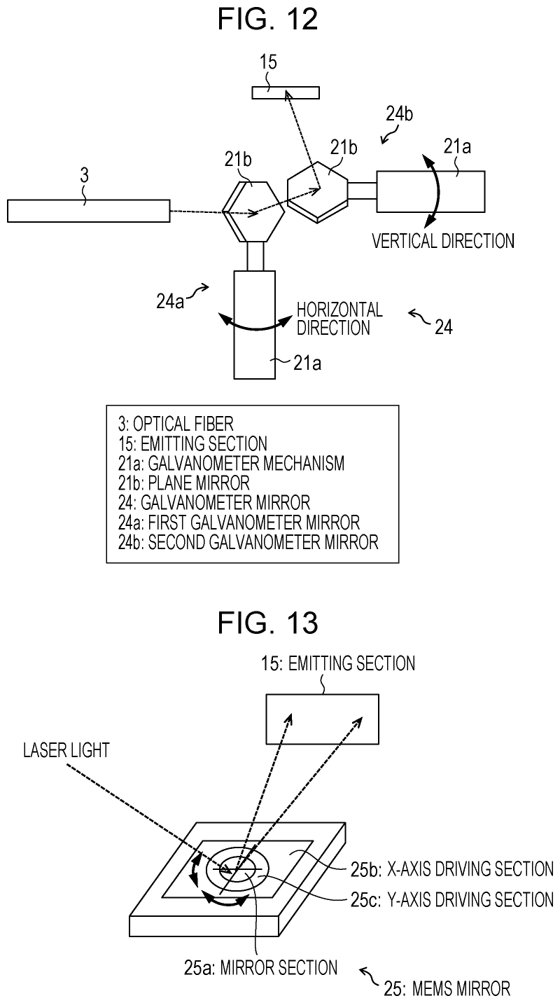

A structure of the galvanometer mirror 24 is described on the basis of FIG. 12. FIG. 12 is a perspective view of a state in which an illumination region on the emitting section 15 is changed by using the two galvanometer mirrors 21.

As shown in FIG. 12, the galvanometer mirror 24, serving as the movable mirror 20B, is a movable mirror for chancing an illumination position of laser light that illuminates the emitting section 15, and includes a first galvanometer mirror 24a and a second galvanometer mirror 24b, which are combined such that their rotation axes are orthogonal to each other. The first galvanometer mirror 24a includes a plane mirror 21b mounted on a uniaxial galvanometer mechanism 21a. The second galvanometer mirror 24b includes a plane mirror 21b mounted on a uniaxial galvanometer mechanism 21a having the same structure.

In the galvanometer mirror 24, whereas the plane mirror 21b of the first galvanometer mirror 24a is rotated in a horizontal direction at the first galvanometer mirror 24a, the plane mirror 21b of the second galvanometer mirror 24b is rotated in a vertical direction at the second galvanometer mirror 24b. As a result, in the galvanometer mirror 24, by rotating each plane mirror 21b in the horizontal direction or the vertical direction corresponding thereto, the plane mirrors 21b are consequentially biaxially rotated. As a result, it is possible to move the spot 15a two-dimensionally on the emitting section 15.

More specifically, the direction in which the spot 15a of the laser light moves on the emitting section 15 (hereunder referred to as the horizontal direction) due to the rotation of the first galvanometer mirror 24a and the direction in which the spot of the laser light moves on the emitting section 15 (hereunder referred as the vertical direction) due to the rotation of the second galvanometer mirror 24b are orthogonal to each other. Therefore, as shown in FIGS. 11(c) and 11(d), the spot 15a of the laser light is capable of scanning the emitting section 15 two-dimensionally in the horizontal direction and the vertical direction.

Light from the emitting section 15 that has received the laser light and that has emitted the light is projected by a projecting lens 16, and a projected illumination pattern corresponds to the spot 15a of the laser light on the emitting section 15. Therefore, since the laser light scans the emitting section 15 two-dimensionally at a sufficient speed, the projected illumination pattern appears to be a planar pattern to toe human eyes.

One or both of the first galvanometer mirror 24a and the second galvanometer mirror 24b may be changed to other movable optical elements, such as a rotating polygon mirror or an MEMS mirror.

Here, as the movable mirror 20B, a biaxial MEMS mirror 25 may be used.

A structure of the biaxial MEMS mirror 25 is described on the basis of FIG. 13. FIG. 13 is a perspective view of the structure of the biaxial PENS mirror 25.

As shown in FIG. 13, the biaxial PENS mirror 25 includes a mirror section 25a, an X-axis driving section 25b that rotates the mirror section 25a, and a Y-axis driving section 25c that rotates the mirror section 25a. The rotation axis of the X-axis driving section. 25b and the rotation axis of the Y-axis driving section 25c are orthogonal to each other. By this, similarly to the two galvanometer mirrors, that is, the first galvanometer mirror 24a and the second galvanometer mirror 24b, one PENS mirror 25 allows the spot 15a of the laser light to scan the emitting section 15 two-dimensionally in the horizontal direction and the vertical direction.

In other words, the PENS mirror 25 is an illumination position changing section that changes an optical path of the laser light emitted from the laser element 2c, and changes the illumination position of the laser light on the emitting section 15.

### (Illumination Region of Spot on Emitting Section)

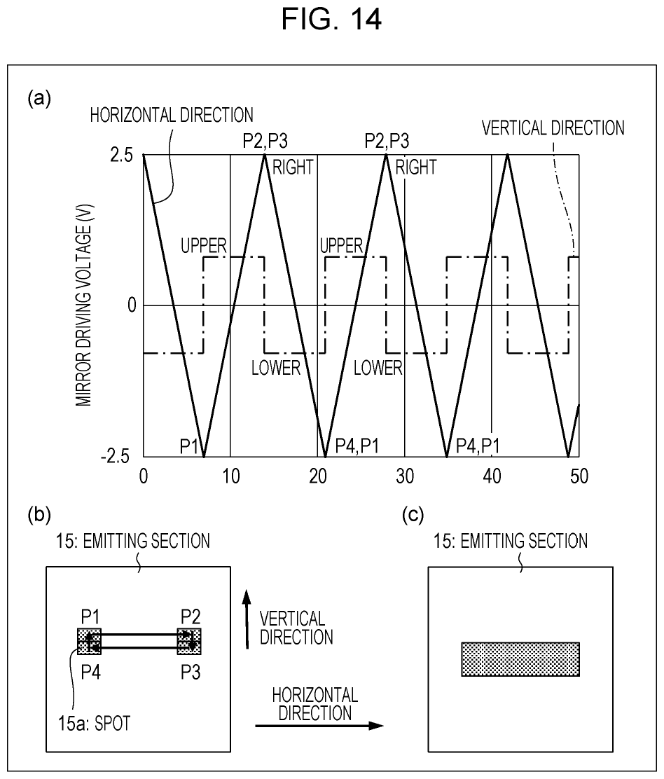

Next, the illumination region of the spot 15a on the emitting section 15 of the illumination device 1B of the embodiment is described on the basis of FIGS. 14(a), 14(b), and 14(c). Here, the galvanometer mirror 24, serving as the movable mirror 20B, is used in the description. FIG. 14(a) is a graph showing a relationship between driving voltage that is applied to the galvanometer mirror 24 and the positions of the spot 15a on the emitting section 15. The horizontal axis indicates the time in msec (milliseconds). The vertical axis indicates the driving voltage, with an upper side being + (plus) and a lower side being − (minus). FIG. 14(b) is a plan view of an illumination state on the emitting section 15 when the spot 15a on the emitting section 15 scans a portion from a position P1 to a position. P4. FIG. 14(c) is a plan view of a residual image of the spot 15a when the spot 15a on the emitting section 15 continuously scans the emitting section. 15 the portion from the position P1 to the position P4.

As shown in FIG. 14(a), by applying a driving voltage of a triangular wave with a frequency of 71.4 Hz (a period of 14 msec) to the galvanometer mechanism 21a of the first galvanometer mirror 24a from plus to minus, and by applying a driving voltage of a rectangular wave from plus to minus to each galvanometer mechanism. 21a of the second galvanometer mirror 24b of the galvanometer mirror 24, each plane mirror 21b undergoes reciprocating rotation.

In the embodiment, when the driving voltage that is applied to the galvanometer mechanism 21a of the first galvanometer mirror 24a becomes a minimum value of, for example, −2.5 V, and the driving voltage that is applied to the galvanometer mechanism 21a of the second galvanometer mirror 24b becomes, for example, +0.8 V, the spot 15a of the laser light is positioned at the position P1, shown in FIG. 14(b), on the emitting section 15. From this state, as shown in FIG. 14(a), the driving voltage that is applied to the galvanometer mechanism. 21a of the first galvanometer mirror 24a is increased up to a maximum value of, for example, +2.5 V. This causes the spot 15a of the laser light to move horizontally to the position P2, shown in FIG. 14(b).

Next, as shown in FIG. 14(a), the driving voltage that is applied to the galvanometer mechanism 21a of the second galvanometer mirror 24b is decreased up to, for example, 0.8 V. This causes the spot 15a of the laser light to move vertically from the position P2, shown in FIG. 14(b), to the position P3. That is, the spot 15a moves from an upper level to a lower level. When the spot 15a moves vertically from the position P2 to the position P3, a very small amount of time is required. However, in order to simplify the description, the time taken is not indicated in FIG. 14(a).

Next, as shown in FIG. 14(a), the driving voltage that is applied to the galvanometer mechanism 21a of the second galvanometer mirror 24b is decreased up to a minimum value of, for example, −2.5 V. This causes the spot 15a of the laser light to move horizontally from the lower level position P3, shown in FIG. 14(b), up to the position P4.

Next, as shown in FIG. 14(a), the driving voltage that is applied to the galvanometer mechanism 21a of the second galvanometer mirror 24b is increased up to +0.8 V. This causes the spot 15a of the laser light to move vertically from the position P4, shown in FIG. 14(b), to the position P1. That is, the spot. 15a moves from the lower level to the upper level in FIG. 14(a), when the spot 15a moves vertically from the position P4 to the position P1, a very small amount of time is required. However, in order to simplify the description, the time taken is not indicated in FIG. 14(a).

By repeatedly periodically performing the driving, as shown in FIG. 14(c), the spot 15a of the laser light can scan the emitting section 15 two-dimensionally in the horizontal direction and the vertical direction.

Here, in the above-described example, the laser element 2c is driven at a constant current, but is not necessarily limited thereto. It is possible to control a projection pattern by turning the laser element 2c on and off or modulating the intensity in synchronism with the movement of the galvanometer mirror 24.

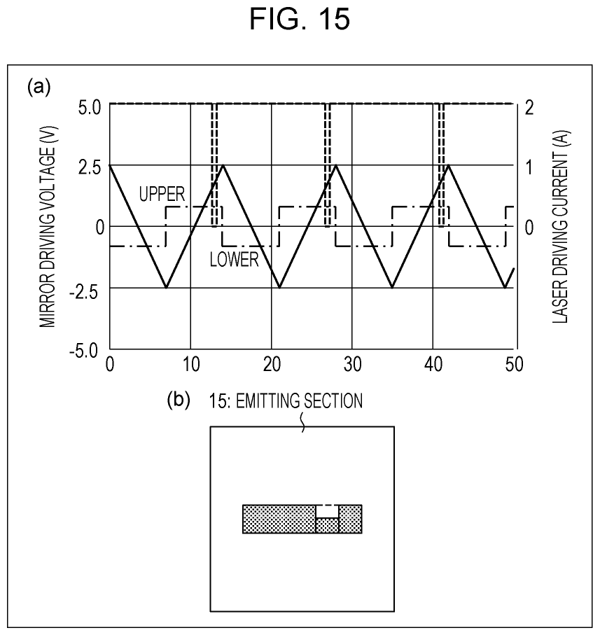

A method of controlling a projection pattern when the laser element 2c is turned on and off in synchronism with the movement of the galvanometer mirror 24 is described on the basis of FIGS. 15(a) and 15(b). FIG. 15(a) is a graph showing a relationship between the driving voltage that is applied to the galvanometer mirror 24, the positions of the spot 15a on the emitting section 15, and driving current of the laser element 2c. The horizontal axis indicates the time in msec (milliseconds). The vertical axis indicates the driving voltage, with an upper side being + (plus) and a lower side being − (minus). The solid line indicates the driving voltage that is applied to the galvanometer mirror 24, and the broken lines indicate the driving current of the laser element 2c. 15(b) is a plan view of a residual image of the spot 15a when continuous scanning is performed by the spot 15a as a result of control shown in FIG. 15(a).

As shown in FIG. 15(a), for example, when the driving voltage that is applied to the first galvanometer mirror 24a of the galvanometer mirror 24 becomes, for example, +2.0 V, and the driving voltage that is applied to the second galvanometer mirror 24b of the galvanometer mirror 24 becomes, for example, +0.8 V, the driving current of the laser element 2c is turned off. By this, as shown in FIG. 15(b), a projection pattern in which only a portion near the right side in the upper level of a scanning region of the spot 15a on the emitting section 15 does not shine is acquired. By changing the time width in which the driving current of the laser element 2c is turned off, it is possible to change the width of a light non-emission region. Further, by changing the timing in which the driving current of the laser element 2c is turned off, it is possible to change a light non-emission position.

In FIG. 15(a), the driving current of the laser element 2c is modulated with the waveform being that of a rectangular wave. However, when the waveform of the driving current of the laser element 2c is, for example, a sinusoidal-wave waveform, a waveform based on Gaussian distribution, or a waveform based on Lorentz distribution, instead of the rectangular-wave waveform, it is possible to realize a projection pattern whose darkness changes in gradations. A pattern in which the number of driving-current off locations of the laser element 2c is more than one and the plurality of locations do not emit light may also be used.

In this way, in the illumination device 1B of the embodiment, the movable mirror 20B allows the scanning direction of the spot 15a or 15b to be changed in a two-dimensional plane. Therefore, the illumination region on the emitting section 15 can be made two-dimensionally wide and the resolution of light distribution is also increased.

### Third Embodiment

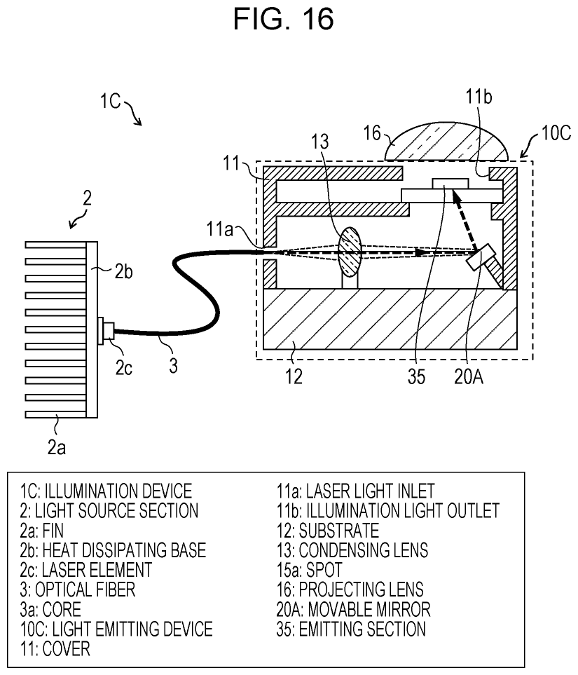

Still another embodiment of the present invention is described on the basis of FIG. 16 below. Structures other that those described in this embodiment are the same as those of the first embodiment and the second embodiment. For the purpose of illustration, members having the same functions as those shown in the figures for the first embodiment and the second embodiment are given the same reference numerals and are not described below.

The illumination device 1A of the first embodiment and the illumination device 13 of the second embodiment are reflecting-type illumination devices in which light is reflected by the emitting section 15.

In contrast, an illumination device 1C of the embodiment differs in that a transmissive-type emitting section 15 is used.

A structure of the illumination device 1C of the embodiment is described on the basis of FIG. 16. FIG. 16 is a schematic structural view of the structure of the Illumination device 1C. In the description, portions that differ from those of the illumination device 1A of the first embodiment and the illumination device IS of the second embodiment are primarily described.

As shown in FIG. 16, in the illumination device 1C of the embodiment, a cover 11 of a light emitting device 10C has a double ceiling. A transparent substrate 36 on which the transmissive-type emitting section 35 is mounted is provided at a laser-light outlet of a first ceiling. A projecting lens 16 is provided thereabove.

Therefore, in the illumination device 1C of the embodiment, light reflected from a movable mirror 20A is incident upon the emitting section 15 via the transparent substrate 36, and light transmitted through the emitting section 15 passes through the projecting lens 16.

The aforementioned transparent substrate 36 is a supporting member that supports the transmissive-type emitting section 15, and is a heat dissipating substrate for allowing heat from the emitting section 15 to escape. It is desirable that the transparent substrate 36 be a glass substrate or a sapphire substrate. It is desirable that a dichroic mirror that transmits laser fight from a laser element 2c and that reflects fluorescence from the emitting section 15 be formed on a surface of the transparent substrate 36.

The other structures are the same as those of the aforementioned illumination device 1A and the illumination device 1B of the second embodiment.

### Fourth Embodiment

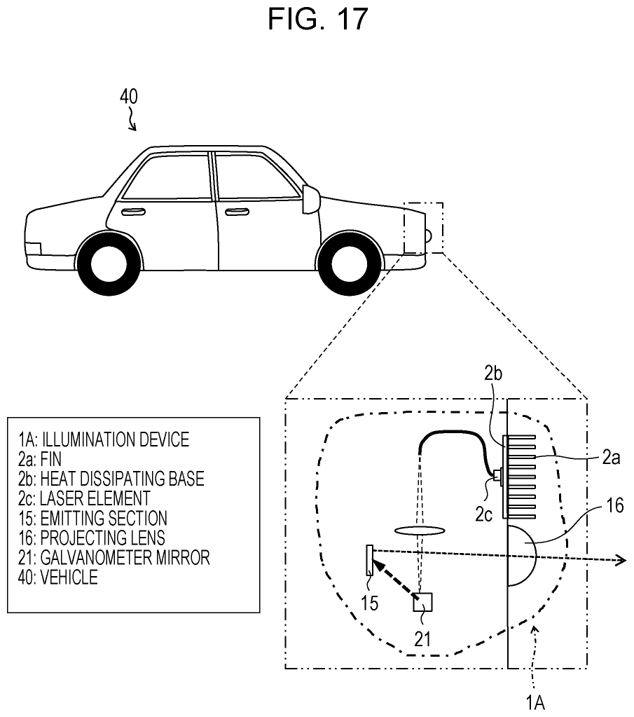

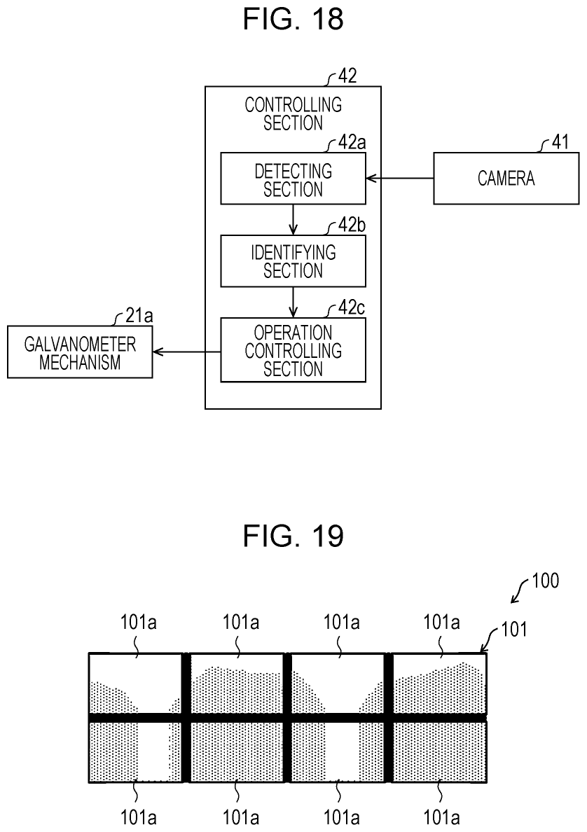

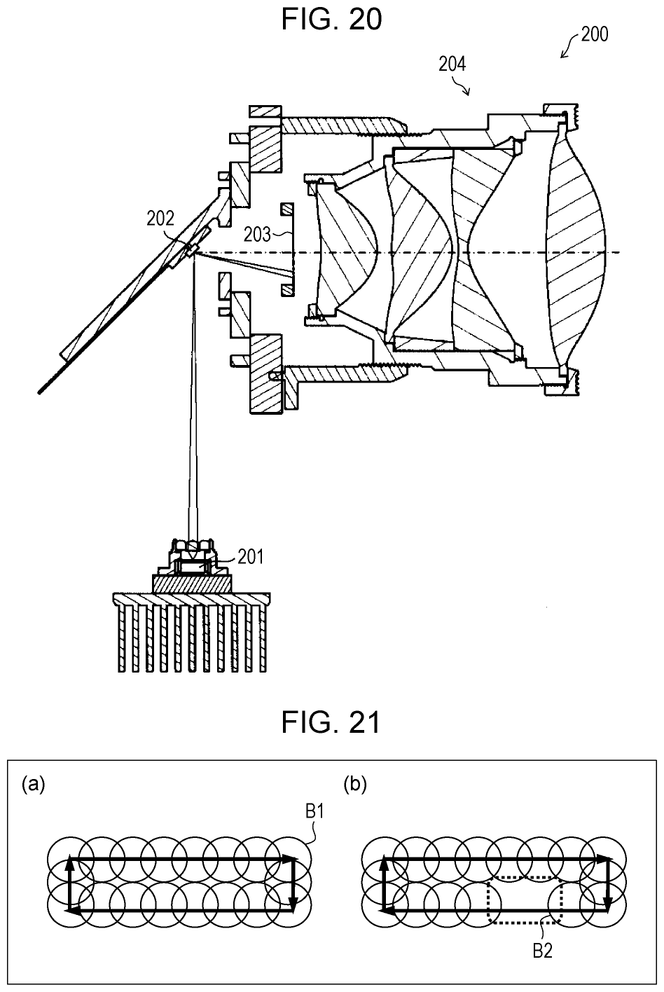

Still another embodiment of the present invention is described on the basis of FIGS. 17 and 18 below. Structures other that those described in this embodiment are the same as those of the first to third embodiments. For the purpose of illustration, members having the same functions as those shown in the figures for the first embodiment to the third embodiment are given the same reference numerals and are not described below.

The illumination devices 1A to 1C of the first to third embodiments can be adapted for use as a vehicular headlight (headlamp). They are also adapted for use as headlamps of moving objects other than vehicles (human beings, ships, airplanes, submarines, rockets, etc.). They are also adapted for use as search lights and projectors, and as lighting equipment.

In the embodiment, the case in which the illumination device 1A is applied to a headlamp called an Adaptive Driving Beam (ADB) headlight is illustrated on the basis of FIGS. 17 and 18. FIG. 17 is a conceptual view of a vehicle 40 including the illumination device 1A of the first embodiment as a headlamp called an Adaptive Driving Beam (ADD) headlight, but is not limited thereto it may obviously include the illumination device 1A of the second embodiment or the illumination device 1C of the third embodiment as an ADB headlamp. FIG. 18 is a schematic block diagram for describing a controlling section 42 of the vehicle 40 shown in FIG. 17.

As shown in FIG. 17, the vehicle 40 includes the illumination device 1A at a front portion (a head) of the vehicle 40. The illumination device 1A is disposed such that the heat dissipating base 2b provided with the fins 2a is positioned at an outer shell of the vehicle 40. Further, the illumination device 1A is disposed such that the projecting lens 16 projects illumination light from the emitting section 15 forwardly of the vehicle 40, but is not limited thereto. The illumination device 1A may be disposed as appropriate in accordance with, for example, the performance and shape of each member of the illumination device 1A and design guidelines of the headlamp of the vehicle.

As shown in FIG. 18, in order to make it possible to control the illumination device 1A as an ADB headlamp, the vehicle 40 further includes a camera 41 and the controlling section 42 including an operation controlling section 42c of the illumination device 1A. Therefore, the illumination device 1A is capable of projecting light having a proper illumination pattern forwardly of the vehicle 40 in accordance wish a traveling state of the vehicle 40. For example, in order to prevent an oncoming vehicle or a preceding vehicle from being bright, it is possible to automatically project an illumination pattern having a light distribution in which only that position is dark.

The camera 41 continuously photographs the vicinity located forwardly of the vehicle 40 including a projection region to which the illumination device 1A projects Illumination light. The camera 41 is disposed, for example, near a rear-view mirror disposed forwardly of the compartment of the vehicle 40. The camera 41 is a vehicle-mounted camera, and may be selected as appropriate in accordance with the speed of movement of the vehicle 40. For example, when the vehicle 40 moves at a speed of 60 km per hour, it is desirable that the frame rate of the camera 41 be greater than or equal to 120 Hz. In addition, it is desirable that the frame rate of the camera. 41 be greater than the frame rate of the illumination device 1A.

The camera 41 is connected to the controlling section 42. From the time when the laser light is emitted from the laser element 2c at the latest, the camera 41 starts a photographing operation, and outputs photographed image data (a moving image) to the controlling section 42.

Instead of the camera 41, an infrared radar that illuminates an object existing forwardly of the vehicle 40 with infrared rays and that detects a reflected wave thereof may be used. Even when an infrared radar is used, similarly to the camera 41, objects existing forwardly of the vehicle 40 can be detected by using a highly versatile technology. In addition, the camera 41 may function as a camera for visible light, as a camera for infrared light, or as a camera for both infrared light and visible light. When the camera 41 is for infrared light, warm-blooded animals including human beings are easily detected. The number of cameras 41 need not be one and may be more than one.

The controlling section 42 performs general control on the vehicle 40, and primarily includes a detecting section 42a, an identifying section 42b, and the operation controlling section. 42c.

The detecting section 42a analyzes the moving image photographed by the camera 41, and detects an object in the moving image. More specifically, when the detecting section 42a acquires the moving image from the camera 41, the object included in a projectable area in the moving image is detected.

When the detecting section 42a has detected the object in the projectable area in the moving image, the detecting section 42a outputs to the identifying section 42b a detection signal indicating coordinate values where the object has been detected.

On the basis of image recognition, the identifying section 42b identifies the type of object at the coordinate values indicated by the detection signal that has been output from the detecting section 42a. More specifically, when the identifying section 42b acquires the detection signal from the detecting section 42a, the identifying section 42b extracts characteristics, such as the speed of movement, the shape, and the position, of the object at the coordinate values that are indicated by the detection signal, and calculates characteristic values obtained by converting the characteristics into numerical values.

Referring to a reference value table that is stored in a storage section (not shown) of the vehicle 40, and in which reference values acquired by transforming the characteristics in correspondence with types of objects into numerical values are controlled, the identifying section 42b searches for the reference value whose error from a calculated characteristic value is within a predetermined threshold value in the reference value table.

For example, in the reference value table, reference values corresponding to, for example, vehicles, road signs, pedestrians, animals, or expected obstacles are previously registered and controlled. When the reference value whose error from the calculated characteristic value is within the predetermined threshold value is identified, the identifying section 42b determines that an object that is indicated by the reference value is the object detected by the detecting section 42a.

When the identifying section 42b determines that the object detected by the detecting section 42a is an object previously registered in the reference value table, the identifying section 42b outputs to the operation controlling section. 42c an identification signal indicating the object and the coordinate values where the object has been detected.

As described in the first embodiment, the operation controlling section 42c controls the galvanometer mechanism 21a and causes it to be in synchronism with a changing operation that changes the illumination position of laser light on the emitting section 15.

In the embodiment, the operation controlling section 42c controls the galvanometer mechanism 21a such that, in accordance with the type of object that is indicated by the identification signal output from the identifying section 42b, projection is performed or is not performed in a predetermined range (detection region of the object) including the coordinate values that are indicated by the identification signal.

For example, when the type of object that is indicated by the identification signal that has been output from the detecting section 42a is an on-coming vehicle, a preceding vehicle, or the like, the operation controlling section 42c controls the galvanometer mechanism 21a so as to form an illumination pattern having a shape that does not allow projection on a region corresponding to a detection region where the on-coming vehicle, a preceding vehicle, or the like has been detected. This makes it possible for the driver of an on-coming vehicle or a preceding vehicle not to perceive glare due to the projected light from the vehicle 40. In this case, it is possible to travel with a high beam being maintained.

When the type of object that is indicated by the identification signal that has been output from the identifying section 42b is a road sign, an obstacle, or the like, the operation controlling section 42c controls the galvanometer mechanism. 21a so as to form an illumination pattern having a shape that allows projection on a region corresponding to a detection region where a road sign, an obstacle or the like has been detected. This makes it possible to call the attention of the driver of the vehicle 40.

### (Example of Realization by Software)

Here, controlling section 42 may be realized by using a logic circuit (IC chip) formed by, for example, an integrated circuit (IC chip), or by using software using a CPU (Central Processing Unit).

In the latter case, the controlling section. 42 includes, for example, a CPU that execute instructions of programs, which are software, that realize each function; ROM (Read Only Memory) or a storage device (these are referred to as “recording media”) that records the programs and various pieces of data so as to be readable by a computer (or the CPU); and RAM (Random Access Memory) that develops the programs. Then, when the computer (or the CPU) reads the programs from the recording medium and executes the programs, the object of the present invention is achieved. As the recording medium, a “non-transitory tangible medium”, such as a tape, a disc, a card, a semiconductor memory, or a programmable logic circuit, may be used. The above-described programs may be supplied to the aforementioned computer via any transmission media that is capable of transmitting the programs (for example, communication networks or broadcast waves). The present invention Carl be realized even with a data signal actualized by electronic transmission of the above-described programs and embedded in a carrier wave.

In this way, the vehicular headlight of the embodiment includes any one of the above-described illumination device 1A, illumination device 1f, and illumination device 1C. As a result, it is possible to provide the vehicular headlight including any one of the illumination device 1A, the illumination device 1f, and the illumination device 1C, which are capable of making linearly clear the bright-dark contrast of a boundary between a bright region, which is an illumination region, and a dark portion in at least one of the horizontal direction and the vertical direction.

The vehicular headlight of the embodiment includes the detecting section 42a that detects an object; and, when the detecting section. 42a detects an object, the movable mirror 20A or 20k, serving as an excitation light Scanning section, changes at least one of the scanning direction and the scanning speed of the spot 15a or 15b with respect to the emitting section 15 or 35 and changes a projection pattern with respect to the object.

As a result, when the object is, for example, a human being, it is possible to make such a portion a dark portion so as not to appear bright, or to make a predetermined region bright.

### [Recapitulation.]

The illumination devices 1A, 1B, and 10 of a first form of the present invention each include the emitting section 15 or 35 having a phosphor that receives excitation light emitted from the excitation light source (the laser element 2c) and emits light, and the excitation light scanning section (the movable mirror 20A or 20B) that continuously changes the position of the spot 15a or the spot 15b of the excitation light on the emitting section 15 or the emitting section 35 in accordance with a predetermined rule, with the spots 15a and 15b having edge portions, each being such that at least a pair of two opposing sides are linear. “Edge portions of each spot are linear” means that each edge portion has a shape that extends along a straight line serving as a reference (reference straight line), and includes a case in which each edge portion is linear and a case in which each edge portion has a gently wavy shape with the reference straight line as a central axis.

According to the invention, the emitting section that has the phosphor receives the excitation light emitted from the excitation light source, and emits light. Here, the illumination device includes the excitation light scanning section, and the excitation light scanning section continuously changes the position of the spot of the excitation light on the emitting section in accordance with a predetermined rule.

In this type of illumination device, specifically, for example, by scanning the emitting section by using the excitation light scanning section, a residual image remains and the entire scanning region becomes an illumination region, so that it is possible to reduce the number of components and illuminate the entire region of the emitting section and to form the light thereof into a projection pattern.

Here, hitherto, since the spot is circular, the boundary between a bright portion and a dark portion is curved. As a result, for example, in vehicular headlight applications, since a pattern in which only a particular area is bright and the other regions are dark is required, it is desirable that the boundary not be curved.

Therefore, in the present invention, the spot has edge portions, each being such that at least a pair of two opposing sides are linear.

This makes it possible for at least a pair of two opposing sides to be linear at the boundary between the bright portion and the dark portion.

Therefore, it is possible to provide an illumination device that is capable of making linearly clear the bright-dark contrast of a boundary between an illumination region and a dark portion in at least one of the horizontal direction and the vertical direction.

In the illumination devices 1A, 1B, and 1C of a second form of the present invention based on the first form, it is desirable that the spot 15a have a rectangular shape in which two pairs of two opposing sides are linear.

This makes it possible to provide an illumination device that is capable of making linearly clear the bright-dark contrast of a boundary between an illumination region and a dark portion in both the horizontal direction and the vertical direction.

In the illumination devices 1A, 1B, and 1C of a third form of the present invention based on the first form or the second form, it is desirable that the light intensity in the spot 15a or 15b of the excitation light on the emitting section 15 or 35 applied from the excitation light source (the laser element 2c) be constant.

This makes it possible to provide an illumination region in which the light intensity in the spot on the emitting section is uniform.

In the illumination devices 1A, 1B, and 1C of a fourth form of the present invention based on any one of the first form to the third form, it is desirable that the excitation light from the excitation light source (the laser element 2c) illuminate the emitting section 15 or 35 via the light guiding member (the optical fiber 3), and the light distribution of the excitation light at the exiting end surface of the light guiding member (the optical fiber 3) is reflected in the light distribution of the spot 15a or 15b of the excitation light on the emitting section 15 or 35.

Therefore, when the distance from the excitation light source to the emitting section is large, by using the light guiding member and by causing the light distribution of the excitation light at the exiting end surface of the light guiding member to be reflected in the light distribution of the spot of the excitation light on the emitting section, it is possible to illuminate the emitting section with the spot without reducing the light intensity of the excitation light from the excitation light source.

In the illumination devices 1A, 1f, and 1C of a fifth form of the present invention based on the fourth form, the light guiding member may include an optical rod or the optical fiber 3 having the core 3a having a rectangular cross section.

By this, since the rectangular cross section of the excitation light that exits from the core is reflected at the emitting section, it is possible to efficiently illuminate the emitting section with the rectangular spot.

In the illumination devices 1A, 1B, and 1C of a sixth form of the present invention based on the fifth form, the optical fiber 3 may be formed from a multi-mode fiber.

By this, since the distribution of the laser light in the inside of the core of the optical fiber is uniform, the distribution of the laser light is a top-hat type distribution, and is not uneven. In addition, the light intensity at an on-off boundary becomes steep.

In the illumination devices 1A, 1B, and 1C of a seventh form of the present invention based on any one of the first form to the sixth form, it is desirable that the excitation light scanning section include the movable mirror 20A or 20B.

This makes it possible to, by the movable mirror, efficiently and continuously change the position of the spot of the excitation light on the emitting section in accordance with a predetermined rule.

In the illumination devices 1A, 1B, and 1C of an eighth form of the present invention based on any one of the first form to the seventh form, the excitation light scanning section (the movable mirror 20A or 20B) allows the scanning speed of the spot 15a or 15b to change.

By this, even if the excitation light source is not turned on and off, it is possible to partly form a dark portion by, for example, increasing the scanning speed of the spot when the position of the spot of the excitation light on the emitting section is continuously changed in accordance with a predetermined rule.

In the illumination devices 1A, 1f, and 1C of a ninth form of the present invention based on any one of the first form to the eighth form, it is desirable that the excitation light scanning section (the movable mirror 20A or 20B) allow the scanning direction of the spot 15a or 15b to be changed in a two-dimensional plane.

Therefore, the illumination region on the emitting section can be made two-dimensionally wide and the resolution of light distribution is also increased.

A vehicular headlight of a tenth form of the present invention includes any one of the above-described illumination device 1A, illumination device 1f, and illumination device 10 based on any one of the first form to the ninth form.

According to the invention above, it is possible to provide the vehicular headlight including any one of the illumination devices, which are capable of making linearly clear the bright-dark contrast of a boundary between an illumination region and a dark portion in at least one of the horizontal direction and the vertical direction.

The vehicular headlight of an eleventh form of the present invention based on the tenth form includes the detecting section 42a that detects an object; and, when the detecting section 42a detects an object, the excitation light scanning section (the movable mirror 20A or 20B) changes at least one of the scanning direction and the scanning speed of the spot 15a or 15b with respect to the emitting section 15 or 35 and changes a projection pattern with respect to the object.

By this, in the vehicular headlight, when the detecting section detects an object in a forward direction, it is possible to change at least one of the scanning direction and the scanning speed of the spot with respect to the emitting section and change a projection pattern with respect to the object. As a result, when the object is, for example, a human being, it is possible to make such a portion a dark portion so as not to appear bright, or to make a predetermined region bright.

### REFERENCE SIGNS LIST

1A, 1B, 1C ILLUMINATION DEVICE
2 LIGHT SOURCE SECTION
2a FIN
2h HEAT DISSIPATING. BASE
2c LASER ELEMENT (EXCITATION LIGHT SOURCE)
3 OPTICAL FIBER (LIGHT GUIDING MEMBER)
3a CORE
10A, 10B, 10C LIGHT EMITTING DEVICE
11 COVER
11a LASER LIGHT INLET
12 SUBSTRATE
13 CONDENSING LENS
15, 35 EMITTING SECTION
15a, 15b SPOT
16 PROJECTING. LENS
20A, 20B MOVABLE MIRROR
21 GALVANOMETER MIRROR (MOVABLE MIRROR)
21a GALVANOMETER MECHANISM
21b PLANE MIRROR
22 POLYGON MIRROR (MOVABLE MIRROR)
22a ROTARY MIRROR
22b ROTARY MECHANISM
23 MEMS MIRROR (MOVABLE MIRROR)
23a MIRROR SECTION
23b DRIVING SECTION
24 GALVANOMETER MIRROR (MOVABLE MIRROR)
24a FIRST GALVANOMETER MIRROR (MOVABLE MIRROR)
24b SECOND GALVANOMETER MIRROR (MOVABLE MIRROR)
25 MEMS MIRROR
25a MIRROR SECTION
25b X-AXIS DRIVING SECTION
25c Y-AXIS DRIVING SECTION
36 TRANSPARENT SUBSTRATE
40 VEHICLE
41 CAMERA
42 CONTROLLING SECTION
42a DETECTING SECTION
42b IDENTIFYING SECTION
42c OPERATION CONTROLLING SECTION
B1, B2 BOUNDARY
P1, P2, P3, P4 POSITION

1. An illumination device comprising:
an emitting section having a phosphor that receives excitation light emitted from an excitation light source and emits light;
an excitation light scanning section that continuously changes a position of a spot of the excitation light on the emitting section in accordance with a predetermined rule; and
a projecting section that projects the light emitted from the emitting section,
wherein the spot has an edge portion in which at least a pair of two opposing sides are linear,
wherein a boundary between a bright portion and a dark portion in a vertical direction is linearly formed in a projection pattern that is projected from the projecting section, and
wherein a position of the boundary between the bright portion and the dark portion is changeable.

2. The illumination device according to claim 1, wherein the excitation light scanning section allows a scanning speed of the spot to be changed.

3. The illumination device according to claim 1, wherein the excitation light scanning section allows a scanning direction of the spot to be changed in a two-dimensional plane.

4. A vehicular headlight comprising:
the illumination device according to claim 1.

5. The vehicular headlight according to claim 4, comprising a detecting section that detects an object,
wherein when the detecting section detects the object, the excitation light scanning section changes at least one of a scanning direction and a scanning speed of the spot with respect to the emitting section and changes a pr pattern with respect to the object.
